(19) United States
(12) Patent Application Publication
(10) Pub. No.: US 2008/0133848 A1
(43) Pub. Date: Jun. 5, 2008

(54) Embedded Memory And Multi-Media Accelerator And Method Of Operating Same

(76) Inventors: Mukesh K. Patel, Fremont, CA (US); Wingyu Leung, Cupertino, CA (US)

Correspondence Address: BEVER HOFFMAN & HARMS, LLP;TRI-VALLEY OFFICE, 1432 CONCANNON BLVD., BLDG. G, LIVERMORE, CA, 94550, US

(21) Appl. No.: 11/566,138

(22) Filed: Dec. 1, 2006

(51) Int. Cl. G06F 12/00

(52) U.S. Cl. 711/154; 711/E12.001

(57) ABSTRACT

A memory device incorporating a multi-media accelerator and an embedded memory, wherein the memory device operates as a standard stand-alone memory when the multi-media accelerator is not enabled. The memory device includes a memory interface that is compatible with multiple types of memory controllers, thereby enabling multiple types of external devices to interact with the multi-media accelerator and access the embedded memory. The embedded memory can be shared between external devices and multi-media devices.

### FIELD OF THE INVENTION

The present invention relates to a memory device that incorporates both a multi-media accelerator and an embedded memory.

### BACKGROUND

Handheld devices such as cell phones are proliferating globally, with most these handheld devices incorporating multi-media functions. These multi-media functions vary in performance and cost. Additionally, the multi-media functions are implemented by the base band processor or an application processor of a cell phone (or the equivalent in other handheld devices). These multi-media functions require their own memory to achieve adequate performance. Often, a dedicated memory, such as a synchronous dynamic random access memory (SDRAM), a mobile double data rate memory (MDDR) or a synchronous pseudo static random access memory (pSRAM) is used to implement the multi-media functions. This memory represents an additional cost for the handheld device, as the baseband processor already has an associated memory, which is used for operating a wireless network. When the multi-media functionality is not operating, the memory dedicated for the multi-media functions is not used. Additionally, the multi-media memory is implemented using a separate chip. Consequently, power consumption is high when running the multi-media functions, undesirably reducing battery life.

One of the largest performance and power consumption factors in mobile multi-media consumer devices is memory. Generally, mobile devices deploy various power management schemes such as sleep mode, standby mode and active mode. These modes are prevalent in cellular phones, where sleep mode is engaged while the phone is in its cradle waiting to receive a call. In this mode, a minimal set of operations are running and it is desirable for all devices which are not actively running to have the lowest leakage current. One of the largest sources of leakage current in sleep mode is memory. The leakage is dependent on the type of memory and the amount of memory or memory elements, as well as logic elements. Typically in memory devices, there is considerable memory on-chip, making memory leakage a dominant factor while in sleep mode.

In standby mode, several functions may be running and may periodically get interrupted by other functions, such as receiving a call while playing a game. If a call is received while playing a game, there would be a resource conflict for the display so the game could be put in standby mode while servicing the incoming call. In standby mode it may be necessary to retain the context for the game, in order to allow the game to continue after the call is terminated. For this reason, it may be necessary to have certain functions in standby mode by keeping some clocks running, while deactivating other clocks and preserving the memory content.

While it is desirable to have very low leakage current in sleep mode and very low operating current in standby mode, it is also very desirable to have very low power consumption while in active mode. In active mode, the application is running continually and accessing the memory, the display and other devices. Running a battery powered device in active mode imposes a relatively large strain on the battery in a short period of time. In order to reduce power consumption significantly during the active mode, it is not only necessary to extensively gate the clocks, thereby reducing logic power, but it is also necessary to have the most efficient access to memory for frame buffer, Z buffer, texture memory and the display list. It is therefore desirable to have all the required memory and the computing elements in the memory device.

Various papers have described embedding memory on a system on a chip (SoC) architecture (e.g., John Poulton, “An Embedded DRAM For CMOS ASICs” (1997), David Patterson et al., “A Case For Intelligent RAM” (1997), and M. F. Deering et al. “FBRAM: A New Form of Memory Optimized for 3D Graphics” (1994)).

Poulton teaches embedding DRAM for use as a register file between multiple processors which are also on the same chip. The chip is a graphics-enhanced memory chip with low voltage swing buses for full voltage swing multiple small page memories, thereby reducing power consumption and boosting performance with wide on-chip buses.

Patterson et al., address the integration of DRAM and logic on a single SoC. Patterson et al. teach integrated RAM (IRAM), which includes DRAM and a processor integrated on a single chip to over come the processor-memory performance gap. Patterson et al. incorporate vector processing with DRAM on the same chip, while utilizing wide buses to achieve high bandwidth. The wide on-chip buses exhibit a low capacitance, thereby reducing the power consumption and allowing higher on-chip bus frequencies.

Deering et al., describe the advantages of integrating graphics functions with DRAM in a chip and using multiple of these chips to produce a frame buffer solution. Deering et al. also teach integrating 3D graphics functions with DRAM on a single chip (FBRAM), wherein performance is enhanced by performing read-modify-write, Z compare and rgba blending in a single write operation. The DRAM memory and the graphics functions are 4-way interleaved, wherein each DRAM bank has its own page buffers. External devices access the FBRAM via a custom render bus and the DRAM is used for graphics functions only. Multiple FBRAMS are required to compose a full frame buffer for 3D graphics.

U.S. Pat. Nos. 5,650,955, 5,703,806, 6,356,497, 6,771,532, 6,920,077 and 7,106,619 by Puar et al. describe a method to integrate DRAM with a graphics accelerator and video logic for a mobile PC. These patents teach a CPU interfacing to a chip which has no external memory interface. Therefore, instead of using pins for a memory interface, the pins are used to provide a PCMCIA interface. The CPU has access to read the embedded DRAM and writes commands to the graphics accelerator via the CPU bus. The chip in these patents provides a CPU interface.

U.S. Pat. No. 6,101,620 by Ranganathan teaches a PC having a chip incorporating internal DRAM and a video display controller which operates with an external DRAM. The frame buffer is split between the external DRAM and the internal DRAM and is multiplexed out to the display interface. A host interface is used to write and read the internal DRAM and the external DRAM. The host interface is one of the buses present in a PC (i.e., a PCI bus, a VESA bus, an EISA bus, or an ISA bus).

The above-described references do not teach operating a chip as a memory device and efficiently sharing the memory of the memory device with a multi-media accelerator. Furthermore, these references do not teach operating a memory device having an interface that can implement more than one standard memory protocol. It would be desirable to have an interface to the memory device which is compatible with standard memory products protocols (e.g., DRAM, MDDR, pSRAM), so that the memory device can be a simple design-in within a system having standard memory buses, while providing multi-media acceleration functions.

### SUMMARY

One objective of the current invention is that the memory in the memory device is made usable for processors or external devices for functions other than multimedia when the multimedia accelerator is not operating, thus achieving the best cost optimization. In one embodiment, the memory in the memory device is an embedded memory with logic. Another aspect of the invention is that the embedded memory can be accessed (or made usable) when both the multimedia accelerator and an external device are running concurrently and using the same memory device. Because processors or external devices may have memory controllers that operate with different types of memory, the present invention includes a memory interface that is capable of operating in accordance with different protocols (i.e., different interfaces, timing and voltages). This memory interface enables the memory device to operate as multiple types of memory.

The present invention also provides a memory interface, which implements 3-D graphics and optionally other multimedia functions with reduced power consumption. For 3D graphics, there are four areas to consider for reduction in power consumption: (1) the logic, (2) the frame buffer where an image is composited, (3) the Z-buffer where the depth values for fragments of an image are stored, and (4) the texture memory.

### BRIEF DESCRIPTION OF THE DRAWINGS

FIG. 1 is a top level diagram showing blocks within a memory device in accordance with one embodiment of the present invention.

FIG. 2 is a table illustrating the manner in which pins of the memory device of FIG. 1 are shared by two protocols in accordance with one embodiment of the present invention.

FIG. 3 is a block diagram of an external device having an MDDR controller, which is coupled to the memory interface of the memory device of FIG. 1 in accordance with one embodiment of the present invention.

FIG. 4 is a block diagram of a mode determination unit and a corresponding mode interface register located within the memory interface of the memory device of FIG. 1 in accordance with one embodiment of the present invention.

FIG. 5 is a table that illustrates four memory protocols implemented by the memory interface of the memory device of FIG. 1 in accordance with one embodiment of the present invention.

FIG. 6 is an expanded block diagram, which illustrates portions of the memory device of FIG. 1 in more detail in accordance with one embodiment of the present invention.

FIG. 7 is a block diagram of a synchronous interface 700 of an embedded memory block of the memory device of FIG. 1, in accordance with one embodiment of the present invention.

FIGS. 8 and 9 are waveform diagrams illustrating the read and write protocol timing, respectively, required to access the embedded memory block of FIG. 7 in accordance with one embodiment of the present invention.

FIGS. 10 and 11 are a waveform diagrams illustrating read and write MDDR protocol timing, respectively, used by an external device to access the embedded memory block of FIG. 7 in accordance with one embodiment of the present invention.

### DETAILED DESCRIPTION

The present invention is a memory device having a memory interface which is configured to operate with one of several standard memory protocols, one or more embedded memory subsystems, a memory mapping circuit, a graphics accelerator for 2D and/or 3D graphics processing, a display mechanism for updating a display. The memory device can be accessed via a memory interface. Optionally a video interface is provided for display purposes (e.g., MDDI). In one mode, the memory device can be operated such that an external device and the graphics accelerator concurrently access the embedded memory subsystems (by arbitrating accesses). In a second mode, the embedded memory subsystems are accessed by either the graphics accelerator or an external device based on setting an access mode bit. In a third mode, the embedded memory subsystems are accessed by an external device only, wherein the memory device acts as a standard memory device such as SDRAM (synchronous DRAM), DDR (double data rate SDRAM), mobile SDRAM, MDDR (mobile double data rate SDRAM), asynchronous pSRAM (pipelined SRAM), synchronous pSRAM, or cellularRAM.

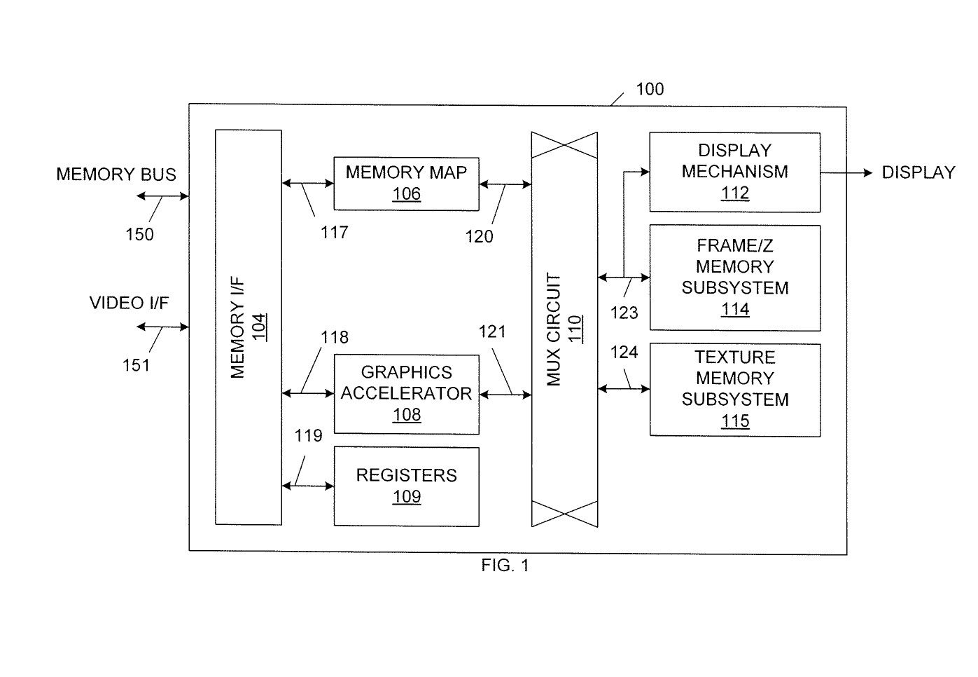

FIG. 1 is a top level block diagram of memory device 100 in accordance with one embodiment of the present invention. Memory device 100 includes memory interface 104, memory mapping circuit 106, graphics accelerator 108, registers 109, multiplexer circuit 110, display mechanism 112 and embedded memory subsystems 114 and 115. Memory device 100 also includes internal buses 117-124 for connecting the various circuit elements. Memory device 100 is configured for coupling to an external memory bus 150 and an external video interface 151.

In the described embodiments, embedded memory subsystem 114 can be used to store frame/Z-buffer data for a graphics application and/or general data. Similarly, embedded memory subsystem 115 can be used to store texture data for a graphics application and/or general data. Although the described embodiments include two embedded memory subsystems 114-115, it is understood that other numbers of embedded memory subsystems 114-115 can be used in other embodiments. In the described embodiments, embedded memory subsystems 114-115 are implemented using DRAM cells, although this is not necessary for all embodiments.

The efficiency in accessing embedded memory subsystems 114-115 can be optimized by implementing a memory architecture comprising multiple small banks of memory (i.e., multi-bank memory), wherein multiple small banks of memory collectively form each memory subsystem. For example, different groups of multiple small banks may be used to implement the frame buffer, Z-buffer and texture buffer of a graphics application. One example of a multi-bank memory architecture which can be used to implement memory subsystems 114-115 is described in U.S. Pat. No. 6,215,497 by Wingyu Leung, which is hereby incorporated by reference in its entirety. Another example of a multi-bank memory architecture which can be used to implement memory subsystems 114-115 is described in U.S. Pat. No. 6,370,073, also by Wingyu Leung, which is also hereby incorporated by reference in its entirety. Other memory architectures can be used in other embodiments of the present invention. Although both of the above-referenced multi-bank memory architectures are typically implemented using DRAM memory cells, other types of memory cells can be used in other embodiments of the present invention.

In FIG. 1, graphics accelerator 108 accesses memory subsystems 114 and 115 using internal bus paths 121 and 123-124. The graphics commands that instruct graphics accelerator 108 to render are provided by an external device (not shown) coupled to memory bus 150. These graphics commands are routed to graphics accelerator 108 by memory interface 104 (via internal bus 118). The external device that connects to memory interface 104 could be a base band processor or an application processor such as those used in a cell phone or a mobile multimedia device. Note that graphics accelerator 108 can be any multi-media accelerator, and is not limited to 3D graphics. Examples of multimedia accelerators that can be used in accordance with the present invention include a video codec, an audio codec or a MIDI player. Multiplexer circuit 110 enables graphics accelerator 108 to access memory subsystems 114-115 via internal buses 121 and 123-124.

In one embodiment, memory device 100 can be used by one or more external devices when graphics accelerator 108 is not enabled to execute the graphics commands. These external devices are coupled to memory device 100 via memory bus 150. Multiplexer circuit 110 provides the mechanism which enables these external devices to access memory subsystems 114-115 via memory interface 104. More specifically, multiplexer circuit 110 allows an external device to access memory subsystems 114-115 using a path that includes memory interface 104, memory mapping circuit 106 and internal buses 117, 120, 123 and 124.

The frame/Z-buffer memory subsystem 114 and the texture buffer memory subsystem 115 are shown as two separate memories, each implemented as a multi-bank memory. However, memory mapping circuit 106 enables an external device to access the two embedded memory subsystems 114 and 115 as a single linearly addressable memory. Memory mapping circuit 106 may map the address space of the two embedded memory subsystems 114-115 such that these two memory subsystems appear as one linearly addressable memory to an external device coupled to memory interface 104. In an alternate embodiment, the frame/Z-buffer memory subsystem 114 and the texture memory subsystem 115 are implemented as a single multi-bank memory.

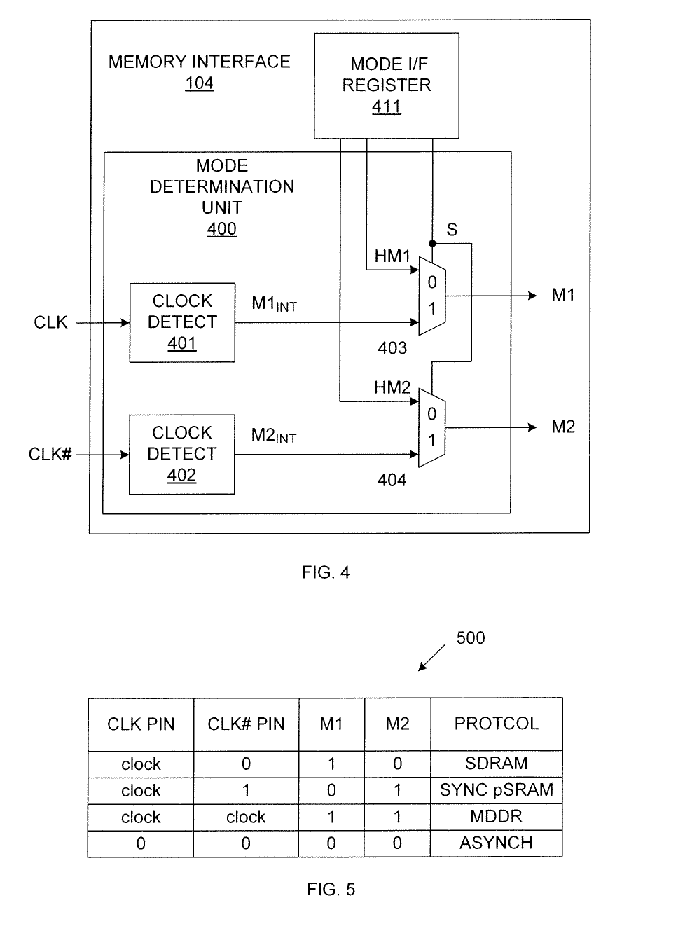

Registers 109 can be accessed by memory interface 104 via internal bus 119. Registers 109 include at least the standard registers available in the standard commercially available cellularRAM, SDRAM and MDDR products. Registers 109 also include memory device specific registers in addition to the registers available in standard commercial memory products. These memory device specific registers include registers to gate various clocks within memory device 100 for power management, to separately reset the graphics and other accelerators, to individually enable or disable graphics accelerator 108, other accelerators (not shown), or a memory interface mode register (see, e.g., memory interface mode register 411 of FIG. 4 below).

In the described embodiment, the memory cells in embedded memory subsystems 114-115 include dynamic cells that require periodic refresh. Power management is incorporated by programming registers 109, which include clock gating registers that gate the clock off from embedded memory subsystems 114 and 115 (or designated banks within these embedded memory subsystems 114-115). The clock gating registers are programmed by an external device. For fine grain power management, each bank, which includes multiple sub-banks, receives a clock which is gated individually or on a sub-bank group basis. When the clock to any bank (or sub-bank) is gated off, the refresh circuitry does not refresh the memory cells of the bank (or sub-bank) and the data in the memory cells is not retained, because the memory cells comprise dynamic cells.

In an alternative embodiment, power management is achieved by keeping the clocks running to maintain the refresh circuitry so data is not lost, but reducing the power consumption by disabling accesses to the individual banks or sub-banks. Clock gating for power management can also be provided for the multimedia functions implemented by logic elements. A power management scheme is also provided where the embedded memory systems 114-115 are combined in a single multi-bank memory where the entire memory can be idled by disabling accesses, but maintaining the refresh mechanism. Other power management levels are incorporated wherein the clock is gated off to the entire single multi-bank memory or to the sub-banks within the single multi-bank memory, either individually or on a sub-bank group basis.

As described in more detail below, memory interface 104 is compatible with one or more standard memory devices. That is, memory interface 104 includes logic that allows external devices to access embedded memory subsystems 114-115 using different protocols. Therefore, from the perspective of an external device, memory interface 104 is capable of implementing a plurality of memory interface protocols associated with a plurality of standard memory devices. In another embodiment, memory interface 104 is capable of implementing a superset of a plurality of standard memory device protocols, and will support the protocols over the superset interface. Examples of standard memory device protocols include those used to implement SDRAM, DDR, mobile SDRAM, MDDR, asynchronous pSRAM, synchronous pSRAM, and cellularRAM.

By enabling connection to a plurality of different standard memory devices, memory interface 104 advantageously allows memory device 100 to be used in systems or devices where such standard memory devices are typically used, e.g., cell phones. As described in more detail below, memory interface allows many of the same pins of memory device 100 to be shared between different interfaces having different protocols. For example, the 16-bit data buses associated with both MDDR and cellularRAM protocols would share the same 16-data pins of memory device 100. (Note that the bus width of memory device 100 is not limited to 16-bits and can be of any width).

Other pins with similarity in function would also be common between protocols. As used herein, the commands associated with a protocol are generally designated as EXCMD signals, the clock signals associated with a protocol are generally designated as EXCLK signals, the data signals associated with a protocol are generally designated as EXDQ signals, and the address signals associated with a protocol are generally designated as EXADR signals.

For a superset of an MDDR interface, an extra select pin, (e.g., 3DCS#) is included to distinguish accesses to graphics accelerator 108 from accesses to the embedded memory subsystems 114-115. When accessing the embedded memory subsystems 114-115, a standard memory product protocol which can include chip select pin (CS#) is used.

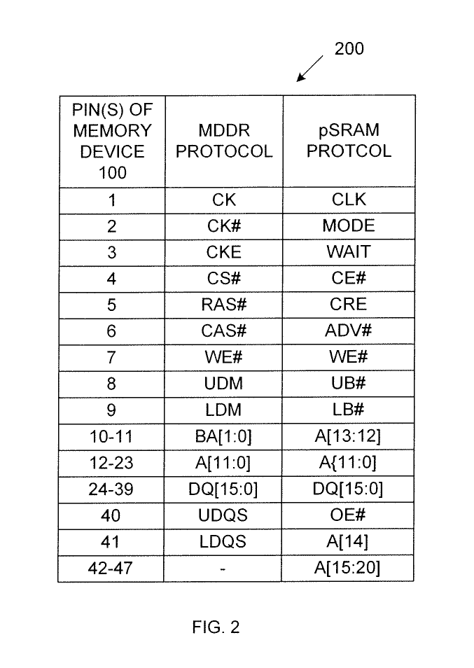

FIG. 2 is a table 200 that illustrates the manner in which pins associated with memory interface 104 are shared to implement either an MDDR protocol or a pSRAM protocol, in accordance with one embodiment of the present invention. While FIG. 2 depicts one example of sharing pins with similar functions between MDDR and pSRAM protocols, it is understood that these pins may be shared in other manners in other embodiments of the present invention. It is also understood that the pins associated with memory interface may be shared between protocols other than MDDR and pSRAM in other embodiments of the invention. Moreover, the pins associated with memory interface 104 may be shared between more than two protocols in other embodiments of the present invention.

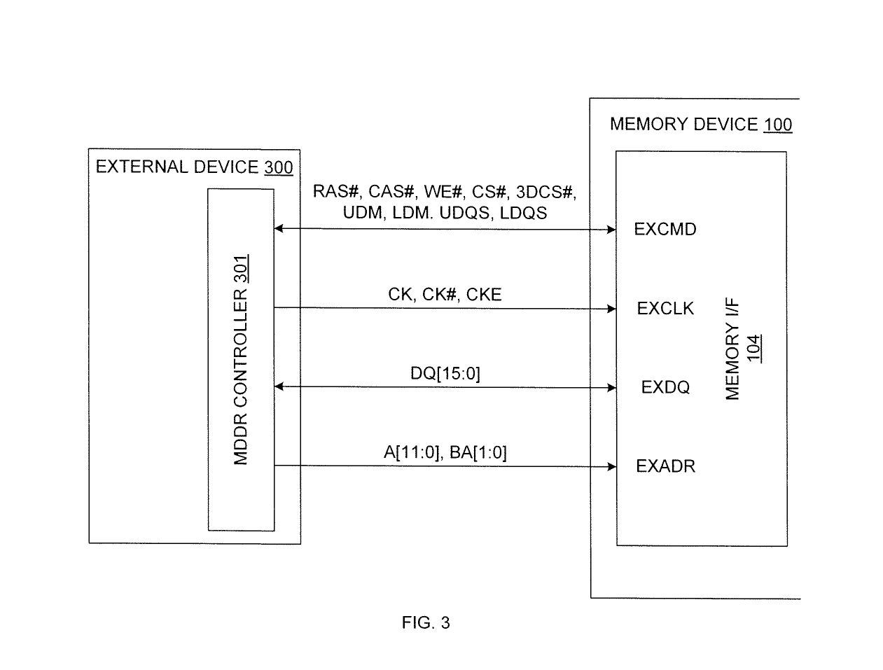

FIG. 3 is a block diagram of an external device 300 having an MDDR controller 301 coupled to memory interface 104 in accordance with one embodiment of the present invention. In accordance with table 200, MDDR controller 301 provides chip select signal (CS#), row address strobe signal (RAS#), column address strobe signal (CAS#), write enable signal (WE#), upper data mask (UDM), lower data mask (LDM), upper data strobe signal (UDQS), lower data strobe signal (LDQS), and optional graphics accelerator/register select signal (3DCS#) to memory interface 104 (as external command signals EXCMD). MDDR controller 301 also provides clock signals CK and CK# and clock enable signal CKE to memory interface 104 (as external clock signals EXCLK). MDDR controller 301 also provides data signal DQ[15:0] to memory interface 104 (as external data signals EXDQ). Finally, MDDR controller 301 provides bank address signals BA[1:0] and memory address signals A[11:0] to memory interface (as external address signals EXADR).

In the described example, external device 300 is a base band processor implementing a MDDR memory controller 301 which is used to access a standard commercial MDDR memory product supporting a MDDR protocol, and having a memory density of 128 Mbits. The standard commercial MDDR memory product may be, for example, Micron part No. MT46H8M16LF. Alternatively, a standard SDBAM memory controller can be implemented in the external device. A standard commercial SDRAM product with a memory density is for example a Micron product with a part number MT48LC8M16A2. Both Micron products, MT46H8M16LF and MT48LC8M16A2 are incorporated herein by reference in their entirety. In this example, external device 300 has a 16-bit bus, and accesses are performed by first asserting a row address A[11:0] and bank address BA[1:0], followed by asserting a column address A[8:0] as well as the bank address BA[1:0], with the appropriate access command. The row and column address pins are shared in the protocol of external device 300, (which accounts for the step wise assertion of the row and column addresses).

Memory interface 104 is capable of supporting multiple protocols. Memory interface 104 is capable of deciphering and responding to signals associated with multiple protocols. However, to be able to implement a particular protocol, memory interface 104 must first be instructed which protocol is being presented. Thus, memory device 100 implements mode signals to identify the protocol of external device 300.

FIG. 4 is a block diagram of a mode determination unit 400 and a corresponding mode interface register 411 located within memory interface 104 in accordance with one embodiment of the present invention. Mode determination unit 400 includes clock detect circuits 401-402 and multiplexers 403-404. The CLK and CLK# signals propagate from the CLK and CLK# pins of memory device 100, through pin level input buffers (not shown), to clock detect circuits 401 and 402, respectively. The CLK and CLK# pins of memory device 100 are capable of receiving a differential clock signal. Alternately, a single clock signal can be provided on the CLK pin, while the CLK# pin is driven to fixed state (i.e., logic ‘0’ or logic ‘1’). The clock detect circuits 401 and 402 detect the nature of the signals on the CLK and CLK# pins, respectively. If clock detect circuit 401 detects the presence of a clock signal on the CLK pin, then clock detect circuit 401 activates the output signal M1_{INT} to a logic high state. Conversely, if clock detect circuit 401 does not detect the presence of a clock signal on the CLK pin, then clock detect circuit 401 deactivates the output signal M1_{INT} to a logic low state. Clock detect circuit 402 generates the output signal M2_{INT} in the same manner in response to the signal received on the CLK# pin.

Mode signals M1_{INT} and M2_{INT} are provided to the ‘1’ input terminals of multiplexers 403 and 404, respectively. The ‘0’ input terminals of multiplexers 403 and 404 are coupled to receive mode signals HM1 and HM2, respectively, from mode interface register 411. The select terminals of multiplexers 403 and 404 are each coupled to receive a select control signal S from mode interface register 411. multiplexers 403 and 404 provide the mode signals M1 and M2, respectively, in response to the select control signal S. The select control signal S is initially set to a logic ‘1’ value, such that multiplexers 403 and 404 route the M1_{INT} and M2_{INT} signals as the mode signals M1 and M2, respectively. Memory interface 104 implements a particular memory protocol in response to the mode signals M1 and M2 and the signal on the CLK# pin.

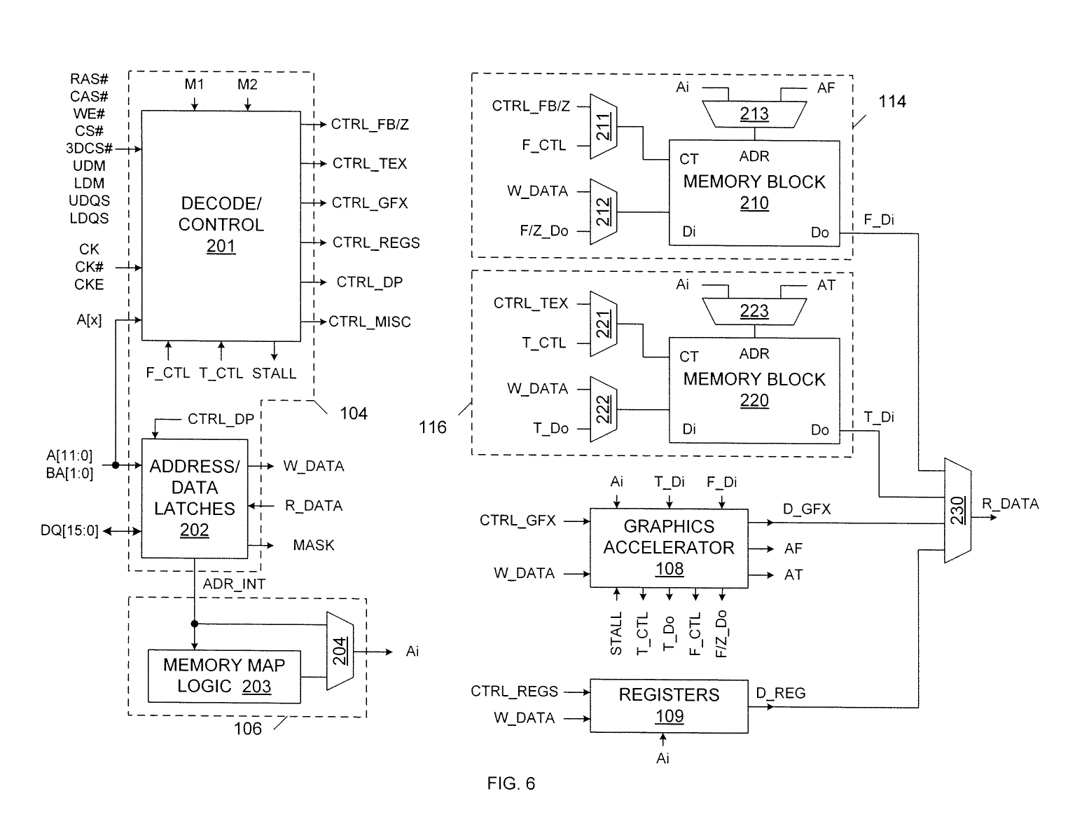

FIG. 5 is a table 500 that illustrates the memory protocols implemented by memory interface 104 in response to different mode signals M1 and M2 and the CLK# signal, in accordance with one embodiment of the present invention. Table 500, which assumes that the select control signal S is activated high, is described in more detail below.

If clock signals are present on both the CLK and CLK# pins of memory device 100, then the M1_{INT} and M2_{INT} signals (and therefore the M1 and M2 signals) are activated to logic ‘1’ values. In response, memory interface 104 is configured to implement an MDDR protocol.

If a clock signal is present on the CLK pin, but the CLK# pin is held at a logic ‘0’ state, then the M1_{INT} signal (and therefore the M1 signal) is activated low, ‘0’ and the M2_{INT} signal (and therefore the M2 signal) is deactivated high, ‘1’. In response, memory interface 104 is configured to implement an SDRAM protocol.

If a clock signal is present on the CLK pin, but the CLK# pin is held at a logic ‘1’ state, then the M1_{INT} signal (and therefore the M1 signal) is activated high and the M2_{INT} signal (and therefore the M2 signal) is deactivated low. In response, memory interface 104 is configured to implement a synchronous pSDRAM protocol.

If there are no clock signals present on the CLK and CLK# pins of memory device 100, then the M1_{INT} and M2_{INT} signals (and therefore the M1 and M2 signals) are deactivated to logic ‘0’ values. In response, memory interface 104 is configured to implement an asynchronous protocol.

In this manner, the CLK#, M1 and M2 signals are used to determine the type of memory protocol presented by external device 300. Note that other coding schemes can be used in other embodiments of the present invention.

Although mode signals M1 and M2 are automatically set upon power-on, these mode signals can be overridden by external device 300 to re-configure the memory protocol. The external device 300 can override the M1 and M2 mode signals by programming the memory mode interface register 411. As described above, memory mode interface register 411 provides the three bits HM1, HM2 and S to multiplexers 403 and 404. Upon power-on, select control bit S is defaulted to a logic ‘1’ state to select the M1_{INT} and M2_{INT} signals. However, the external device 300 may subsequently set the mode select bits HM1 and HM2 to a desired state by writing to mode interface register 411. External device 300 may also overwrite the select control bit S to have a logic ‘0’ state. Under these conditions, the mode select bits HM1 and HM2 are provided as the mode select signals M1 and M2, respectively, thereby controlling the protocol implemented by memory interface 104.

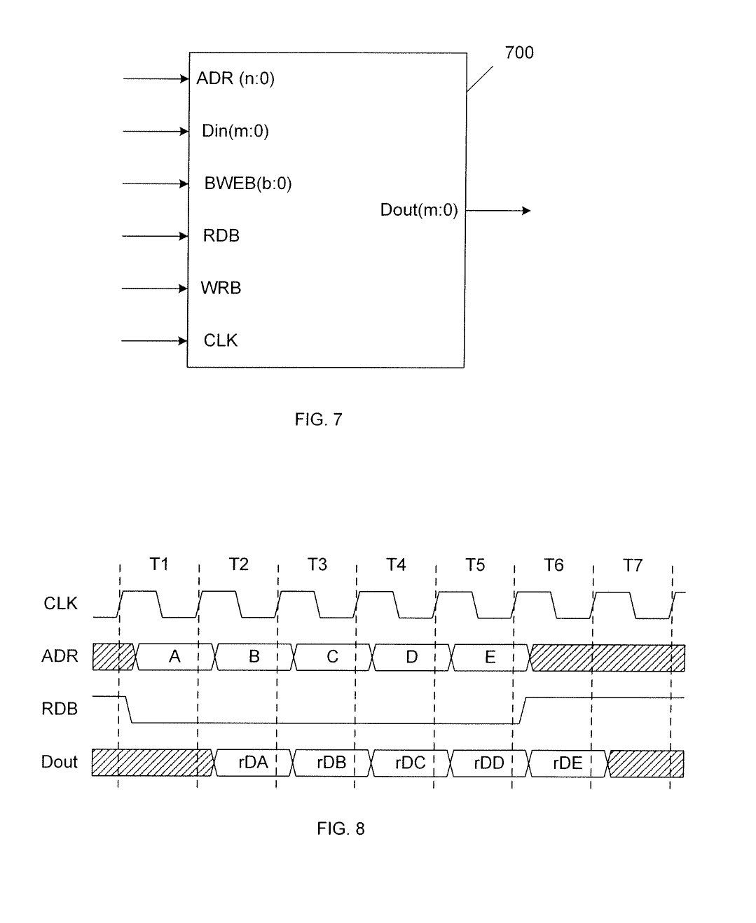

FIG. 6 is an expanded block diagram, which illustrates portions of memory device 100 in more detail in accordance with one embodiment of the present invention. Thus, FIG. 6 illustrates decode/control logic 201 and address/data latches 202 located within memory interface 104; memory mapping logic 203 and multiplexer 204 located within memory mapping circuit 106; memory block 210 and multiplexers 211-213 present within embedded memory subsystem 114; memory block 220 and multiplexers 221-223 located within embedded memory subsystem 116; graphics accelerator 108; registers 109; and multiplexer 230.

Decode/control logic 201 receives control signals from an external device via pin level input/output buffers (not shown). In the embodiment illustrated in FIG. 6, the external device has an MDDR controller (see, FIG. 3). Decode/control logic 201 also receives the mode determination signals M1 and M2 generated by mode determination unit 400 (FIG. 4).

External device 300 requires access to registers 109, graphics accelerator 108 and embedded memory subsystems 114 and 115. In the described embodiments, the address space utilized by graphics accelerator 108 is mapped to the lower range of the available address space.

Memory device 100 appears as a standard commercial product to external device 300. Appropriate software libraries and drivers for the external device 300 and memory device 100 enable the use of graphics accelerator 108, access registers 109 and embedded memory subsystems 114-115 in memory device 100. Note that each of the four banks addressed by bank address BA[1:0] is constructed as a single memory or as multiple memories, each having a multi-bank architecture.

In one embodiment, when access to graphics accelerator 108 is required, external device 300 drives the chip select signal CS# to a logic high state (de-selecting memory sub-systems 210 and 220) and concurrently drives the 3DCS# signal low to access functions within the graphics accelerator 108 or registers 109. At the same time, external device 300 provides the row and bank addresses A[11:0] and BA[1:0] to the external address pins (EXADR) of memory interface 104. Conversely, when access to embedded memory systems 114 and 115 is required, external device 300 drives the chip select signal CS# to a logic low state, there by selecting the memory sub-systems 210 and 220 and concurrently drives the 3DCS# signal to a logic high state (de-selecting the graphics accelerator 108 and registers 109). At the same time, external device 300 provides the row and bank addresses A[11:0] and BA[1:0] to the external address pins (EXADR) of memory interface 104.

In one embodiment, the lower three bank addresses (BA[1:0]=00, 01, 10) are used for addressing registers 109 and other memories in graphics accelerator 108, and the uppermost bank address BA[1:0]=11) is used for addressing configuration registers, when CS# is high and 3DCS# is low.

In another embodiment, accesses between graphics accelerator 108, registers 109 and embedded memory subsystems 114 and 115 are distinguished without the extra 3DCS# pin by having a larger addressing range at memory interface 104 and decoding different smaller address ranges within memory device 100 to access graphics accelerator 108, registers 109 and embedded memory subsystems 114 and 115. This may be accomplished by having an extra row address or column address. In this embodiment, all accesses are made by asserting the chip select signal, CS# low.

In the described embodiment, decode/control circuit 201 receives an address signal A[x] to further distinguish accesses to the graphics accelerator 108 and registers 109. The address signal A[x] is at least one address bit sourced from the external device 300.

Memory interface 104 includes decode/control circuit 201 to determine external device access to graphics accelerator 108, registers 109 and embedded memory subsystems 114-115. Memory interface 104 also has control circuits for each type of memory protocol available in memory device 100. As described above, the mode bits M1 and M2 along with the CLK# signal determine which control circuits are active at any time.

The protocols presented at memory interface 104 are generally incompatible with the synchronous interface of the multi-bank embedded memory subsystems 114 and 115. Each of the embedded memory subsystems 114 and 115 has an address bus ADR, a data input bus Di, a data output bus Do, and a control signal bus CT.

Decode/control circuit 201 includes multiple finite state machines (FSM) for the different types of memory protocols presented by an external device, and also includes logic to decode the CLK#, M1 and M2 bits to identify the memory protocol of the external device. In one embodiment, the decoded CLK#, M1 and M2 bits enable the appropriate FSM according to FIG. 5. In another embodiment, multiple FSMs are optimally combined as one larger FSM with the larger FSM being controlled at least by the CLK#, M1 and M2 bits.

Embedded memory subsystem 114 is accessed as follows. Decode/control circuit 201 generates a set of control signals CTRL_FB/Z, which are provided to multiplexer 211 of embedded memory subsystem 114 (i.e., the embedded frame/Z-buffer memory). Multiplexer 211 also receives a set of control signals F_CTL generated by graphics accelerator 108. Multiplexer 212 receives write data signals W_DATA from address/data latches 202. Multiplexer 212 also receives data signal F/Z_Do provided by graphics accelerator 108. Multiplexer 213 receives address signal Ai from memory mapping circuit 106. Multiplexer 213 also receives address signal AF from graphics accelerator 108. Multiplexers 211-213 are controlled by memory interface 104, thereby allowing memory subsystem 114 to be accessed by either external device 300 or graphics accelerator 108.

Embedded memory subsystem 115 is accessed as follows. Decode/control circuit 201 generates a set of control signals CTRL_TEX, which are provided to multiplexer 221 of embedded memory subsystem 115 (i.e., the embedded texture memory). Multiplexer 221 also receives a set of control signals T_CTL generated by graphics accelerator 108. Multiplexer 222 receives write data signals W_DATA from address/data latches 202. Multiplexer 222 also receives data signal T_Do provided by graphics accelerator 108. Multiplexer 223 receives address signal Ai memory mapping circuit 106. Multiplexer 223 also receives address signal AT from graphics accelerator 108. Multiplexers 221-223 are controlled by memory interface 104, thereby allowing memory subsystem 115 to be accessed by either external device 300 or graphics accelerator 108. More specifically, multiplexers 211-213 and 221-223 are controlled by control signals CTRL_MISC generated by decode/control circuit 201.

Decode/control circuit 201 also generates control signals CTRL_GFX, which are provided to graphics accelerator 108. Graphics accelerator 108 also receives the write data signals W_DATA from address/data latches 202, and address signal Ai and from memory mapping circuit 106. Graphics accelerator 108 also receives output data signals F_Di and T_Di provided by embedded memory subsystems 114 and 115, respectively for reading frame/z and texture data. Graphics accelerator 108 provides output data signals D_GFX for reading registers and memories within the graphics accelerator 108. Note that in one embodiment, graphics accelerator 108 can be paused by a STALL signal provided by decode/control circuit 201 in the event that the memory sub-systems 210 and 220 are busy due to external device accessing the memory sub-systems 210 and 220.

Decode/control circuit 201 also generates control signals CTRL_REGS for controlling access to registers 109. Registers 109 also receive the write data signals W_DATA and the address signals Ai. In response, registers 109 provide output data signals D_REG.

Decode/control circuit 201 also provides control signals CTRL_DP, which are used by address/data latches 202 to latch addresses from external device 300 and data being transferred to and from the external device 300. Address/data latches 202 receive external device addresses and write data, which are latched in response to a subset of the CTRL_DP signals. The set of control signals CTRL_FB/Z, CTRL_TEX and CTRL_DP are asserted due to external device 300 or graphics accelerator 108 requiring access to the embedded memory subsystems 114-115. Decode/control circuit 201 receives the access control signals (e.g., CS#, CAS#, WE#, CS#, 3DCS#, UM# and LM#) from the external device via memory interface 104 and the control signals F_CTL and T_CTL from graphics accelerator 108 to determine weather an access is initiated by the external device 300 or the graphics accelerator 108. One of the bits in the registers 109 indicates which device is allowed access to the memory device 100 at any time (i.e., external device 300 or graphics accelerator 108). This bit is programmed by an external device. In order to avoid a deadlock, the registers 109 can be accessed by the external devices while the graphics accelerator 108 is accessing the embedded memory subsystems 114-115. The status of graphics accelerator 108 can be read concurrently with the graphics accelerator 108 accessing the embedded memory subsystems 114-115. The data mask bits (MSK) found in standard SDRAM/MDDR products are also latched in address/data latches 202 with the aid of the CTRL_DP signals.

Read data from the embedded memory subsystems 114-115, graphics accelerator 108, and registers 109 are selected with multiplexer 230 and latched in address/data latches 202 and provided to the external device 300 using a subset of the CTRL_DP signals.

External devices access the embedded memory subsystems 114-115 as one contiguously mapped memory. Although the memories 114-115 are two physically separate memories, memory map logic 203 maps contiguous linear external device addresses to access the two embedded memories. Multiplexer 204 selects the mapped output of memory map logic 203 when embedded memory subsystems 114-115 are accessed, and selects non-mapped addresses when the graphics accelerator 108 or the registers 109 are accessed by an external device. The selected address Ai from multiplexer 204 is further multiplexed with the addresses from the graphics accelerator 108 to access the embedded memory subsystems 114-115 using multiplexers 213 and 223. Graphics accelerator 108 outputs a frame buffer address AF and a texture address AT. As described above, multiplexer 213 is used to select the mapped external address Ai or the frame buffer address AF to access the frame/Z-buffer memory 114. Similarly, multiplexer 223 is used to select the mapped external address Ai or the texture buffer address AT to access the texture memory 115.

The external device data (EXDQ) to be written into memory device 100 by external device 300 is latched in address/data latches 202 and produced as write data signals W_DATA.

In another embodiment, the control signals CTRL_FB/Z and CTRL_TEX are produced by decode/control circuit 201 to comply with the required control signals (by using F_CTL and T_CTL) of the embedded memory blocks 210 and 220 of FIG. 6, due to accesses initiated by either an external device or the graphics accelerator 108, in which case multiplexers 211 and 221 are not required.

The above embodiments describe external devices accessing the embedded memory subsystems 114-115 when graphics accelerator 108 is disabled. In another embodiment, an arbiter present in decode/control unit 201 is used to arbitrate memory accesses between the external devices via the memory interface 104 and the graphics accelerator 108. In order to accommodate memory access conflict due to the external device 300 and the graphics accelerator when only simultaneously attempting to access the embedded memory subsystems 114-115, the STALL signal is asserted by decode/control circuit 201, whereby graphics accelerator 108 would wait to access the embedded memory subsystems (i.e., stall) during a memory access. In another embodiment, a WAIT signal is asserted by the memory device pin, for sampling by an external device in which case the external device 300 would wait until the WAIT signal is de-asserted to complete an access or to start a new access. An example of a memory device which supports a WAIT pin is cellularRAM.

The embedded memory subsystems 114-115 can be large enough to allow for the graphics memories as well as additional memory for use by external devices for other functions. In such a case, the embedded memory subsystems can be logically partitioned to accommodate external devices as well as devices such as graphics accelerators to operate concurrently. In one embodiment, one of the logical partitions is used by graphics accelerator 108, and the second logical partition is used by external devices 300. The second logical partition of embedded memory acts as a standard memory device when accessed via the memory interface 104. Such an embodiment allows a cell phone user to suspend any game operation when answering a call and resume once the call is terminated. Alternatively, both the call and game can run concurrently. The call can be a person calling to talk or another device over a wireless network to interactively share the playing of a game.

With a graphics frame buffer with a VGA display which is 640×480 pixels, each pixel being 2 bytes, the memory for double frame buffering is 1228800 bytes. The Z-buffer for a 2-byte Z range is 614400 bytes. The total Frame and Z memory required is 1843200 bytes. For two textures with a base size of 640×480 with a texel depth of 2 bytes and associated Mip-Maps, the texture memory size is 1638400 bytes. The total embedded memory in one embodiment is 64 Mbits (8 MBytes), space constructed as 4 banks of 16 Mbits (2 MBytes), wherein each bank is constructed with a multi-bank architecture. Each bank of 2 Mbytes is addressed with a 20-bit address to access 2097152 address locations (2²⁰ for a 16 bit data bus).

In this embodiment, the first bank is large enough to store the frame and Z buffer. The second bank is large enough to store the textures. The extra storage space left in the memory of the first and second bank is utilized for other functions such as stencils planes for the graphics and/or a display list for the graphics. The third and fourth banks are used by external devices for other uses.

From an external device perspective, the individual banks are addressed using the bank address signals BA[1:0]. To access the third and fourth banks, when the graphics accelerator 108 is operational, BA[1:0] are given values of “10” and “11” when asserting the external command signals (EXCMD) for an MDDR protocol. An external device may provide bank address signals BA[1:0] having values of “00” or “01” to access the frame buffer and texture memory or the display lists, by coordinating or synchronizing with graphics accelerator 108. When the graphics accelerator 108 is not operating, the memory device 100 functions as a standard memory device wherein all four banks of memory are accessed as desired by external devices by asserting appropriate access commands and addresses with a MDDR protocol. In this case, the four banks are accessed by asserting appropriate bank address signals BA[1:0] with values of 00, 01, 10 or 11 to access the first, second, third and fourth banks, respectively. Additionally, row address and column addresses are asserted at the external address pins (EXADR), where in one embodiment the row address range is A[11:0] and the column address range is A[7:0].

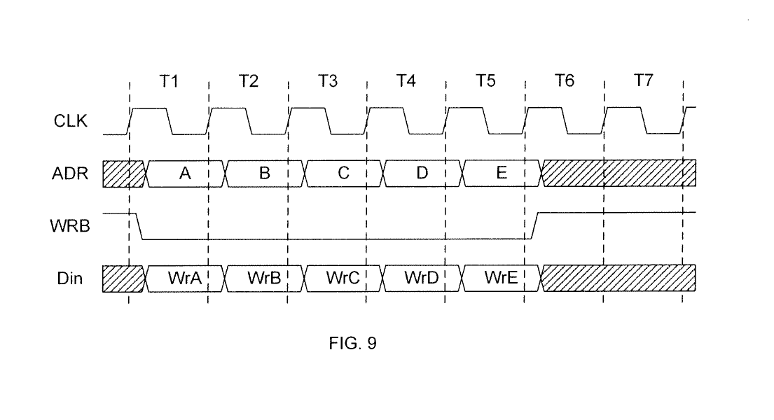

In the described embodiment, embedded memory blocks 210 and 220 of embedded memory subsystems 114 and 115 each has a synchronous interface requiring dedicated clock, address and data signals. FIG. 7 is a block diagram of a synchronous interface 700 for embedded memory blocks 210 and 220, in accordance with one embodiment of the present invention.

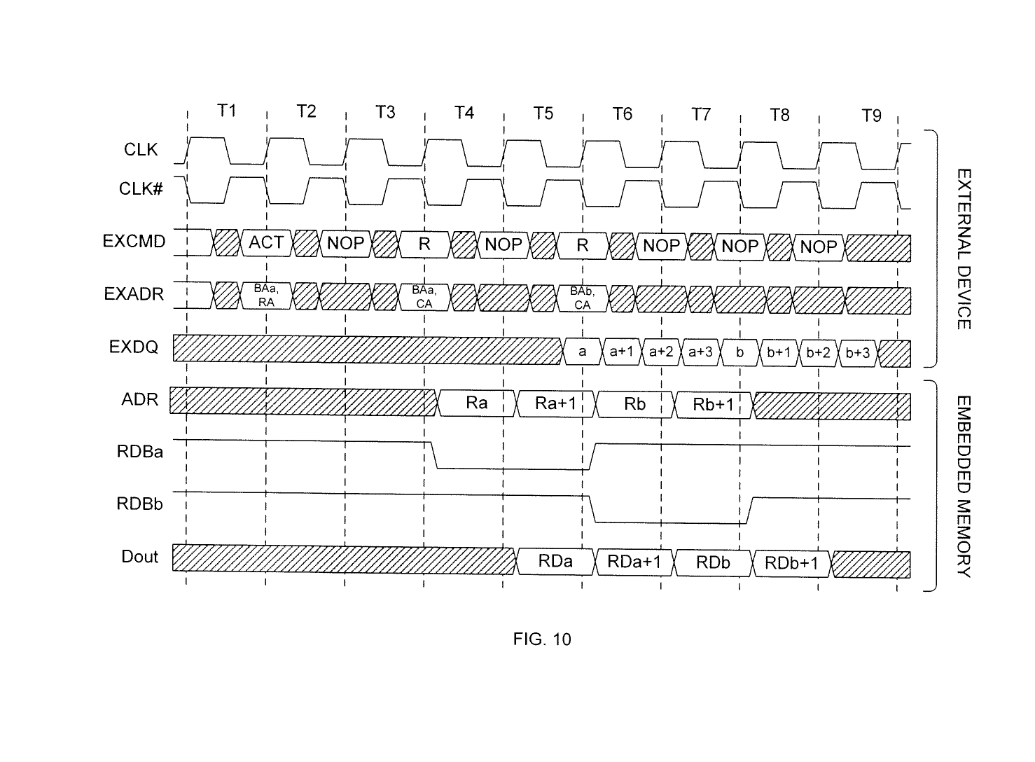

FIGS. 8 and 9 are waveform diagrams illustrating the protocol timing required to access the embedded memory blocks 210 and 220 in accordance with one embodiment of the present invention. More specifically, FIGS. 8 and 9 shows the protocol timing for read and write operations, respectively.

As shown in FIG. 8, for a read operation by a requesting device, an address ‘A’ is asserted on the ADR address bus of the embedded memory block during the clock cycle T1. The address bus is sampled by the embedded memory block with the rising edge of the clock signal CLK at the end of cycle T1. A read control signal RDB is also asserted during cycle T1. The read control signal RDB is sampled by the embedded memory block at the end of cycle T1 with the rising edge of the clock signal CLK. A valid read data value rDA for address A is output on the memory data bus shown as Dout during cycle T2, to be sampled by the requester. The next read address ‘B’ is also asserted during cycle T2 for which an output data ‘rDB’ is produced during cycle T3. FIG. 8 illustrates the read operation in this manner until the read control signal RDB is de-asserted and no more read operations are pending. The read requests and the corresponding read addresses A through E can be from one or more devices, either external or internal to the memory device 100.

As shown in FIG. 9, a write operation starts with the assertion of an address ‘A’ on the ADR bus during cycle T1 (as in a read operation) and the assertion of a write control signal WRB during cycle T1. Under these conditions, the embedded memory block detects a write operation. The write data value WrA to be written to address A, is also asserted on the Din bus of the embedded memory block during cycle T1. The address ‘A’ on the ADR bus, the write control signal WRB on the CT bus, and the write data value ‘WrA’ on the Din bus are sampled by the embedded memory block at the end of cycle T1 with the rising edge of the clock signal CLK.

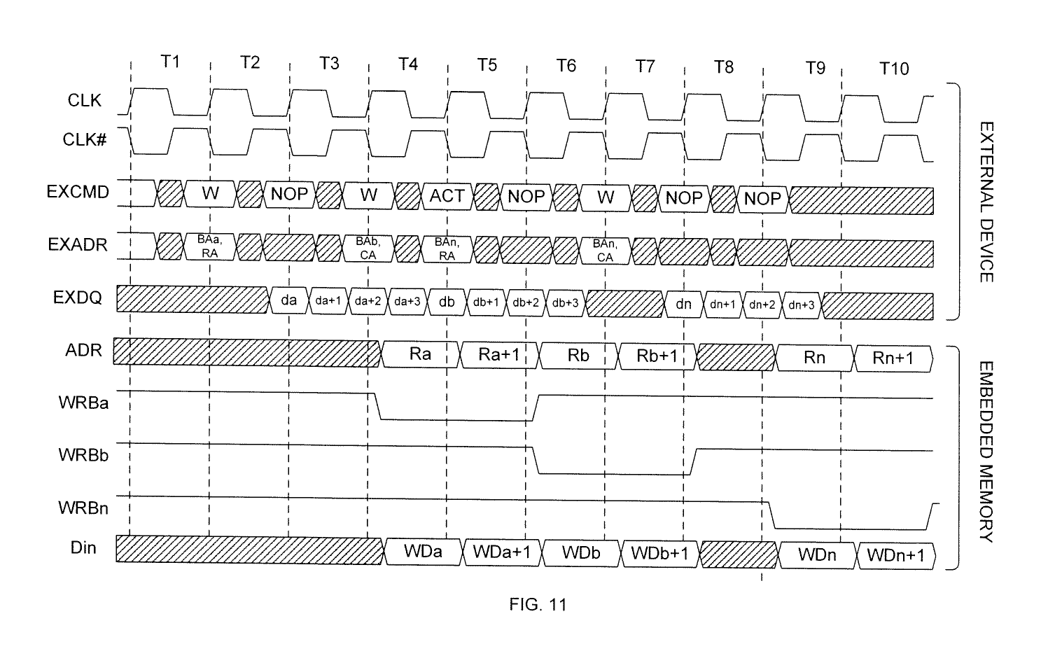

FIG. 10 is a waveform diagram illustrating an external device using an MDDR protocol timing to read the embedded memory of memory device 100. While not all signals for the MDDR protocol are shown, it would be apparent to one skilled in the art as to the use of the signals not shown. The MDDR protocol (with the exception of signals not shown) comprises assertion of the clock signal CLK, the external command signals EXCMD, the external address signals EXADR and the data bus signals EXDQ. The full protocol is disclosed in the incorporated references. The control signals EXCMD are asserted on the memory interface 104 by an external device using the MDDR protocol. The control signals asserted include at least chip select signal CS#, RAS#, CAS#, and WE# (and optionally 3DCS#) in addition to data strobe signals. The control signals EXCMD are sampled by memory interface 104 on the rising edges of the clock signal CLK.

The commands are the same as in the incorporated references. The embedded memory subsystems include multiple banks of memory, each bank having multiple sub-banks of memory.

FIG. 10 illustrates a new read access initiated at the end of cycle T1, with the assertion of an activate command ‘ACT’, the desired row address ‘RA’ and the desired bank ‘BAa’. The activate command ‘ACT’, bank address ‘BAa’ and row address ‘RA’ are latched using CLK at the end of cycle T1. FIG. 10 shows the memory device 100 is programmed to operate with a column access latency of two clock cycles (CL=2) and burst length of 4 in accordance with the standard MDDR protocol. After some elapsed time, during which a non-operation command (NOP) is asserted, a read command ‘R’ is asserted at the EXCMD inputs of memory device 100 during cycle T3, and are sampled by memory interface 104 at the rising the edge of cycle T3. The column address ‘CA’ and the bank address ‘BAa’ are also asserted during cycle T3 and sampled by memory interface 104 at the end of T3 with the rising edge of CLK. The row addresses ‘RA’ are latched and available in cycle T2 and the column and bank addresses, ‘CA’ and ‘BAa’ respectively, are latched and available in cycle T4. The bank address ‘BAa’ asserted during cycle T3 could be of any open bank, although FIG. 10 shows the same bank address BAa as asserted during cycle T1. The latched addresses in the memory interface 104 propagate through the mapping logic circuit 106 and are asserted on the ‘ADR’ bus of the embedded memory during cycle T4. A FSM also asserts RDBa control signal to the embedded memory during cycle T4 and the memory outputs the read data value ‘RDa’ at the Dout bus during cycle T5. Both the output data bus Dout and the input data bus Din are two times wider than the memory interface bus supporting the 16-bit EXDQ MDDR protocol. It will be apparent to those skilled in the art that multiples other than 2 times (including less than one) are also possible. EXDQ data is output at twice the clock rate with CLK and CLK#. The data value ‘RDa’ on the Dout bus is output in two phases to the EXDQ bus in accordance with the MDDR protocol. Half the Dout data is output as ‘a’ in the second half of cycle T5 and the second half is output in the first half of cycle T6 as ‘a+1’. Because the burst length is four, two more data values are read from the memory. The FSMs discussed produce and assert the next embedded memory address ‘Ra+1’ during cycle T5 on the ADR bus for reading from the embedded memory. The memory outputs ‘RDa+1’ on the Dout data bus during cycle T6. This output RDa+1 is provided on the EXDQ pins in the second half of cycle T6 and the first half of cycle T7.

FIG. 10 also shows a second burst of 4 reads initiated by asserting a read command during cycle T5. Additionally, a new bank address, ‘BAb’, and column address ‘CA’ are asserted during cycle T5. Once again the FSM asserts the latched and mapped addresses ‘Rb’ as well as control signal ‘RDBb’ to bank B during cycle T6, and the memory outputs the data value ‘RDb’ on the output data bus Dout. As with data value ‘RDa’, data value ‘RDb’ is output to the EXDQ pins in two phases, in the second half of cycle T7 and first half of cycle T8. Because the burst length is four, the FSMs in the memory device produce and assert the next address ‘Rb+1’ during cycle T7 on to the ADR bus for reading from the embedded memory. The memory provides data value ‘RDb+1’ on the Dout bus in cycle T8, which is output to the EXDQ pins in the second half of cycle T8 and the first half of cycle T9.

Data strobes (not shown) indicating the output of valid data, in accordance with the standard MDDR protocol are also asserted when outputting data on the external data bus EXDQ.

FIG. 11 shows two consecutive bursts of four words of data written to the embedded memory by an external device using the MDDR protocol. Data is written to the memory device 100 by an external device at twice the clock rate by using the clock signals CLK and CLK#. A write command W, a bank address BAa and a column address CA are asserted during cycle T1 to an already open bank. The write command W, bank address BAa and column address CA, are latched by memory interface 104 at the end of cycle T1 by the rising edge of the CLK signal. Memory device 100 is programmed to operate with a column access latency of two cycles and a burst length of four. Data value ‘da’ is written by an external device on EXDQ bus starting in the second half of cycle T2. Because the external data EXDQ is written at twice the CLK rate, both CLK and CLK# rising edges are used to latch the data values ‘da’, ‘da+1’, ‘da+2’ and ‘da+3’. The command and the burst length are used by the FSM in the memory interface to sequence latching of the EXDQ data. The latched addresses propagate through the mapping logic circuit 106 and are asserted onto the ADR address bus of the embedded memory during cycle T4. The first two data words ‘da’ and ‘da+1’ of latched burst data are concatenated and asserted on the Din bus (shown as ‘WDa’) of the embedded memory during cycle T4 along with the assertion of the memory write control signal ‘WRBa’. Because in this exemplary embodiment the embedded memory has a data bus width of 2 times greater than the EXDQ bus, a burst of 4 words produces 2 writes into the embedded memory during cycles T4 and T5 (data words ‘da+2 and da+3 are shown asserted as data value ‘WDa+1’). Another write command W is asserted by an external device during cycle T3, along with a bank address BAb and column address CA to produce another consecutive write burst of 4 words. The additional write command W, bank address BAb and column address CA are latched by the clock signal at the end of cycle T3. The written data words db, db+1, db+2 and db+3 are asserted consecutively in a burst starting during the second half of cycle T4. The EXDQ data words db, db+1, db+2 and db+3 are latched at memory interface 104 using rising edges of both the CLK and CLK# signals, and are asserted on the Din bus of the embedded memory during cycles T6 and T7 for writing into the embedded memory. The latched addresses propagate through the mapping logic circuit 106 and are asserted onto the ADR address bus of the embedded memory during cycles T6 and T7 along with the embedded memory write control signal WRBb. The memory write control signals WRBa and WRBb are de-asserted after cycles T5 and T7, respectively, until further write operations are required at those particular banks.

FIG. 11 shows an activate command ACT, a new bank address BAn and row address RA asserted during cycle T4 by an external device and latched at the memory interface 104 with the rising edge of CLK at end of cycle T4. The activate command opens a new bank BAn and activates a row RA in the bank. A write command is issued during cycle T6 along with the newly opened bank address BAn and column address CA, which are latched at the end of cycle T6 with the rising edge of the clock signal CLK. A burst of 4 data write words dn, dn+1, dn+2 and dn+3 is produced and asserted at the EXDQ pins by an external device starting in the second half of cycle T7. The burst data words dn, dn+1, dn+2 and dn+3 are latched using both the CLK and CLK# signals at memory interface 104. These data words are written into the embedded memory during cycles T9 and T10. The latched addresses are also asserted on the memory address bus ADR, as is the write control signal WRBn, during cycles T9 and T10. The reference incorporated herein (i.e., Micron Part No: MT46H8M16LF) has two bits for designating the bank address BA. This limits the number of banks to 4 banks. Because the present invention can support more banks, it is possible to have more bits for the bank address BA (e.g., 3 bits would enable 8 banks and 4 bits would enable 16 banks). In one embodiment, the higher order row address bits RA are used to implement more banks or sub-banks with the 4 banks.

The present invention is not limited to one on-chip accelerator such as graphics accelerator 108. It would be apparent to those skilled in the art how to include multiple accelerators. The address and data multiplexers would have to be expanded to accommodate multiple accelerators. Although the invention has been described in connection with several embodiments, it is understood that this invention is not limited to the embodiments disclosed, but is capable of various modifications, which would be apparent to a person skilled in the art. Accordingly, the present invention is limited only by the following claims.

1. A method of operating a memory device, the method comprising:
enabling and disabling a multi-media accelerator of the memory device;
accessing an embedded memory array of the memory device using a memory protocol when the multi-media accelerator is disabled; and
operating the memory device as a multi-media accelerator when the multi-media accelerator is enabled.

2. A method of claim 1, further comprising selecting the memory protocol from a plurality of memory protocols.

3. (canceled)

4. The method of claim 2, further comprising:
monitoring one or more pins of the memory device; and
selecting the memory protocol in response to signals detected on the one or more pins of the memory device.

5. The method of claim 1, further comprising accessing the embedded memory array with an external device while the multi-media accelerator is enabled.

6. The method of claim 4, further comprising logically partitioning the embedded memory array for use by an external device and the multi-media accelerator.

7. The method of claim 5, further comprising arbitrating accesses to the embedded memory array between the external device and the multi-media accelerator.

8. The method of claim 1, further comprising implementing the embedded memory array with multiple groups of memories.

9. The method of claim 8, further comprising mapping the multiple groups of memories as one linearly addressable memory.

10. The method of claim 8, further comprising implementing the embedded memory array with a multi-bank architecture.

11. The method of claim 1, further comprising performing two-dimensional and/or three-dimensional rendering with the multi-media accelerator.

12. A method of operating a memory device, the method comprising:
logically partitioning an embedded memory array;
enabling concurrent operation of a multimedia device in one logical partition of the embedded memory array, and external access in a second logical partition of the embedded memory array; and
operating the second logical partition of the embedded memory array using a selected memory protocol.

13. The method of claim 12, further comprising selecting the memory protocol from a plurality of predetermined memory protocols.

14. (canceled)

15. A memory device comprising:
a memory interface;
a multi-media accelerator coupled to the memory interface;
an embedded memory array coupled to the memory interface;
means for operating the embedded memory array as a stand alone via the memory interface when the multi-media accelerator is disabled, and operating the embedded memory array as memory of the multi-media accelerator when the multi-media accelerator is enabled.

16. The memory device of claim 15, wherein the memory interface is configured to receive one or more external signals, and in response, select a memory protocol for the memory device.

17. (canceled)

18. The memory device of claim 16, wherein the memory device includes a first clock pin for receiving a clock signal and a second clock pin for receiving a complementary clock signal, wherein the memory interface is configured to select the memory protocol in response to signals on the first and second clock pins.

19. The memory device of claim 15, further comprising a multiplexer circuit coupled to the memory interface, and configured to enable an external device to access the embedded memory array while the multi-media accelerator is operating.

20. The memory device of claim 19, wherein the embedded memory array is logically partitioned for use by an external device and the multi-media accelerator.

21. The memory device of claim 19, further comprising arbitration logic used to enable the embedded memory array to be accessed an external device or the multi-media accelerator.

22. The memory device of claim 15, wherein the embedded memory array comprises a plurality of embedded memory arrays.

23. The memory device of claim 22, further comprising mapping logic configured to map the plurality of embedded memory arrays as one linearly addressable memory for access via the memory interface.

24. The memory device of claim 15, wherein the embedded memory array comprises a plurality of memory banks arranged in a multi-bank architecture.

25. The memory device of claim 15, wherein the multi-media accelerator comprises two-dimensional/three-dimensional (2D/3D) graphics accelerator.

26. A memory device comprising:
an embedded memory array logically partitioned into a first logical partition and a second logical partition;
a multimedia accelerator; and
a memory interface coupled to the embedded memory array and the multi-media accelerator, and configured to enable concurrent operation of the multimedia accelerator and an external device, wherein the multimedia accelerator accesses the first logical partition of the embedded memory array, and the external device accesses the second logical partition of the embedded memory array using a standard memory protocol.

27. The memory device of claim 26, wherein the memory interface is configured to select the standard memory protocol from a plurality of memory protocols.

28. (canceled)
